(19) United States
(12) Patent Application Publication
(10) Pub. No.: US 2018/0069432 A1
(43) Pub. Date: Mar. 8, 2018

(54) INDUCTIVE POWER RECEIVER

(71) Applicant: PowerbyProxi Limited, Freemans Bay, Auckland (NZ)

(72) Inventor: Ali ABDOLKHANI, Freemans Bay, Auckland (NZ)

(73) Assignee: PowerbyProxi Limited, Freemans Bay, Auckland (NZ)

(21) Appl. No.: 15/558,049

(22) PCT Filed: Mar. 9, 2016
(86) PCT No.: PCT/NZ2016/050036

§ 371 Date: Sep. 13, 2017

Related U.S. Application Data
(60) Provisional application No. 62/132,646, filed on Mar. 13, 2015.

(51) Int. Cl. H02J 50/12; H01F 38/14; H04B 5/00; H02M 1/34; H02J 7/00

(52) U.S. Cl. CPC H02J 50/12; H01F 38/14; H02J 7/007; H02M 1/34; H04B 5/0037

(57) ABSTRACT

An inductive power receiver comprising: a power pick up stage a semi-autonomous converter connected to the power pick up stage; and a controller configured to regulate the power delivered to a load based on at least one control device associated with the converter.

### FIELD

This invention relates generally to a converter. More particularly, the invention relates to a converter for an inductive power receiver.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency. The current in the resonant circuit may then be converted to DC for the load.

The receiver converter may be configured or controlled to generate a DC current of a desired form and amplitude. In some instances, it may be desirable for the frequency of the converter to match the resonant frequency of the resonant transmitting coil and/or the resonant receiving coil.

One known type of converter used in IPT systems is a push-pull converter. Push-pull converters typically rely on an arrangement of switches that, by means of co-ordinated switching, cause the current to flow in alternate directions through the receiving coil or coils. By controlling the switches, the output DC current supplied to the load can be controlled.

A problem associated with push-pull converters is that, in order to reduce switching losses and EMI interference, the switches should be controlled to be switched on and off when the voltage across the switch is zero i.e. zero-voltage switching (ZVS). Implementing ZVS often requires additional detection circuitry to detect the zero crossing and control circuitry to control the switches accordingly. This additional circuitry adds complexity and expense to the converter. Further, some detection and control circuitry may not be able to meet the demands of high frequency converters.

Accordingly, the invention provides an improved inductive power receiver, or at least provides the public with a useful choice.

### SUMMARY

According to one exemplary embodiment there is provided an inductive power receiver comprising a semi-autonomous or fully autonomous converter.

According to a further embodiment there is provided an inductive power receiver comprising:

a power pick up stage
a semi-autonomous converter connected to the power pick up stage; and
a controller configured to regulate the power delivered to a load based on at least one control device associated with the converter.

According to a still further embodiment there is provided an inductive power receiver comprising:

a power pick up stage
an autonomous converter connected to the power pick up stage supplying power to a load.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any document in this specification does not constitute an admission that that document is prior art, is validly combinable with any other document or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a block diagram of an inductive power transfer system;

FIG. 2 is a block diagram of a receiver;

FIG. 3 is an example circuit of the converter;

FIG. 4 is a block diagram of the gate controller;

FIG. 5 is a graph of switching timings for the circuit;

FIG. 6 is a circuit of another example converter;

FIG. 7 is a block diagram of the gate controller;

FIG. 8 is a circuit of the feedback controller; and

FIG. 9 is a circuit of the feedback controller.

### DETAILED DESCRIPTION

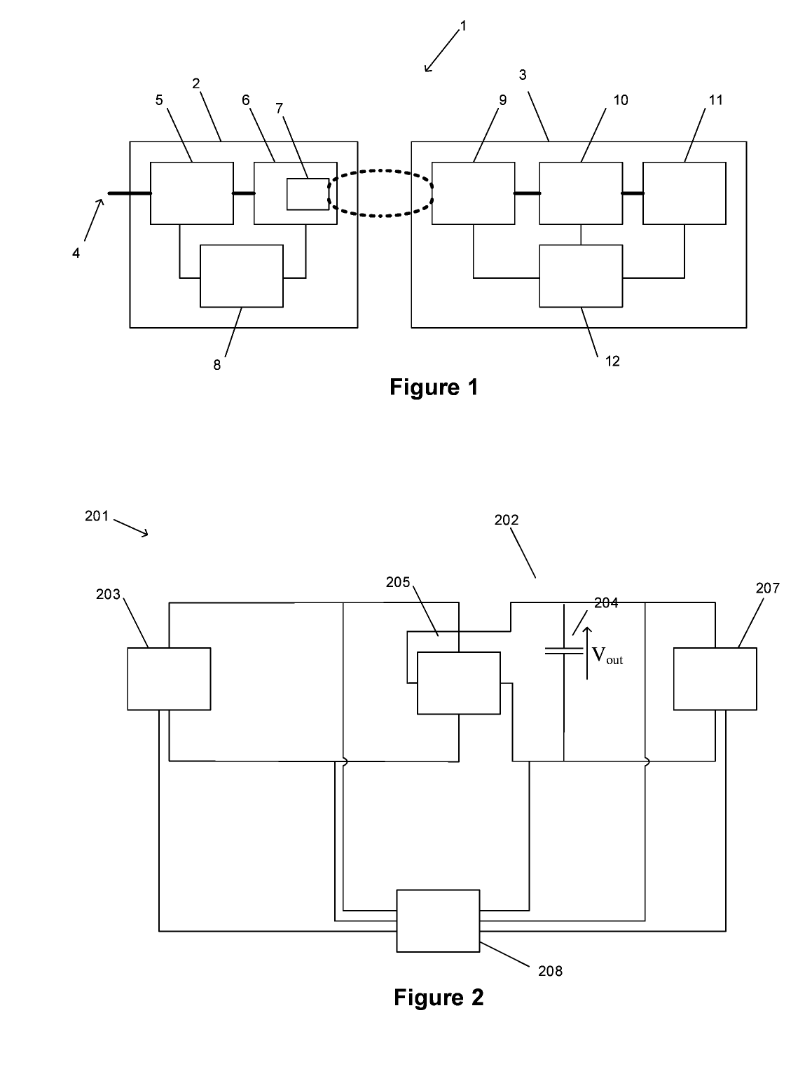

An inductive power transfer (IPT) system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil or coils 7 may also be considered to be separate from the inverter 6. The transmitting coil or coils 7 may be connected to suitable capacitors (not shown) either in parallel or series to create a resonant circuit.

A controller 8 may be connected to each part of the inductive power transmitter 2. The controller 8 may receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coil or coils 7, inductive power receiver detection and/or communications.

The inductive power receiver 3 includes a power pick-up stage 9 connected to power conditioning circuitry 10 that in turn supplies power to a load 11. The power pick-up stage 9 includes inductive power receiving coil or coils. When the coils of the inductive power transmitter 2 and the inductive power receiver 3 are suitably coupled, the alternating magnetic field generated by the transmitting coil or coils 7 induces an alternating current in the receiving coil or coils. The receiving coil or coils may be connected to capacitors and additional inductors (not shown) either in parallel, series or some other combination, such as inductor-capacitor-inductor, to create a resonant circuit. In some inductive power receivers, the receiver may include a controller 12 which may control tuning of the receiving coil or coils, operation of the power conditioning circuitry 10, characteristics of the load 11 and/or communications. The controller 12 may have one or more units/components, and may be a controller such as a microcontroller, PID, FPGA, CPLD, ASIC, etc. Further, it may be possible to integrate significant parts of the entire wireless receiver circuit onto a single integrated circuit.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. Other configurations may be used depending on the application. The use of the term “coil”, in either singular or plural, is not meant to be restrictive in this sense.

Current induced in the power pick-up stage 9 by transmitting coil or coils 7 will typically be high frequency AC at the frequency of operation of the transmitting coil or coils 7, which may be for example, 20 kHz, up to hundreds of megahertz or higher. The power conditioning circuitry 10 is configured to convert the induced current into a form that is appropriate for load 11, and may perform for example power rectification, power regulation, or a combination of both.

FIG. 2 shows a block diagram of an inductive power receiver, according to an example embodiment. Example inductive power receiver 201 comprises example power conditioning circuitry 202 which may perform the combined functions of power rectification and power regulation. The AC voltage generated by power pick-up stage 203 is rectified by rectification stage 205 to Vₒᵤₜ, which is the voltage appearing across DC output capacitor 204. Power pick-up stage 203 may be a parallel tuned resonant circuit, an LCL circuit, or other pick-up according to the application.

The rectification stage 205 may be semi-autonomous, although autonomous or non-autonomous may be used depending on the application. In the present description, the term “autonomous” is used to describe a process or configuration of control in which no active control or control separate and/or independent of the circuitry or function being controlled is used; conversely the term “non-autonomous” is used to describe a process or configuration of control in which only active control or control separate and/or independent of the circuitry or function being controlled is used; such that, the term “semi-autonomous” is used to describe a process or configuration of control in which a combination of autonomous and non-autonomous control is used for the circuitry or function being controlled. Semi-autonomous converters may include various topologies, for example push-pull, flyback, full bridge, etc. Semi-autonomous switching is normally provided by closed loop feedback control, so that the switching frequency follows drifts in the resonant frequency to maintain ZVS. However depending on the application, a converter controlled for partial ZVS or hard switching may also be used. One or more of the rectifier switches may be independently controlled to provide a regulation function of the load voltage.

In the semi-autonomous configuration, controller 208 provides active control to a portion of the rectification control devices.

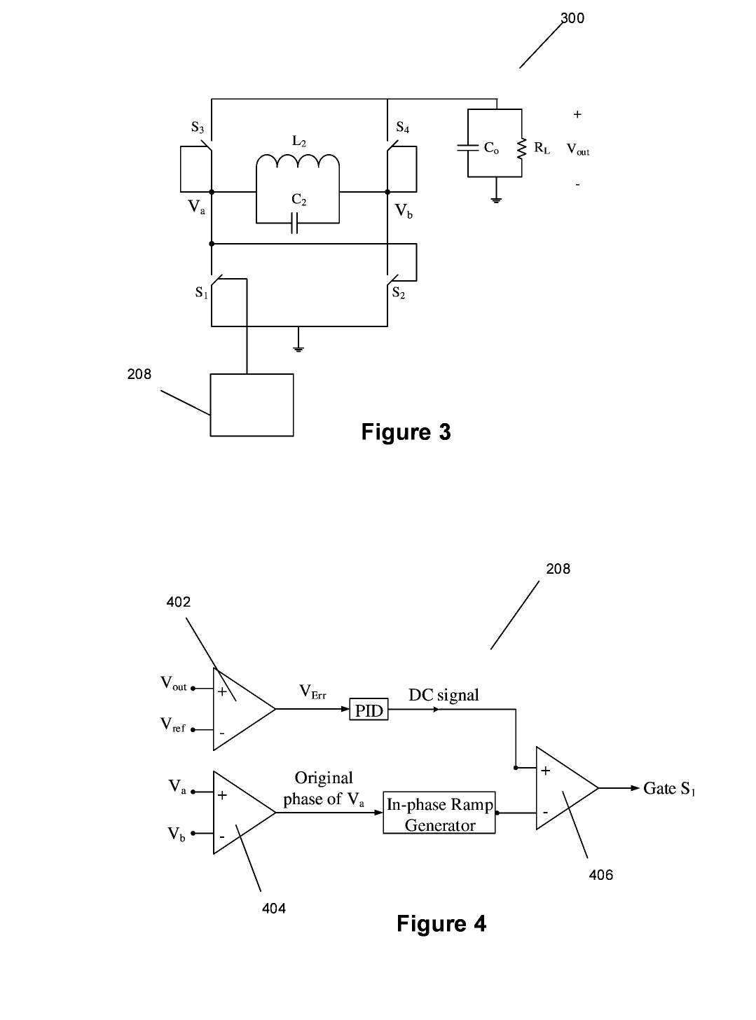

FIG. 3 shows an example semi-autonomous converter 300. In this case the gates of switches S₂, S₃ & S₄ are connected to the resonant tank to be autonomously operated, thereby ensuring ZVS as the operation of S₂, S₃ and S₄ follows the frequency of a resonant tank formed by inductor L₂ and capacitor C₂. Switch S₁ on the other hand is actively controlled by controller 208 using negative feedback to regulate the load voltage. The control method employed by controller 208 is based on phase shift control where each two switches operate together diagonally. For instance, S₁ and S₄ are operated (e.g., turned on and off) together and similarly S₃ and S₂ are operated together. To this end the gate of S₂ is connected to the same side of the resonant tank compared to S₃, but to the opposite side of the resonant tank compared to S₄.

FIG. 4 shows an example of the controller 208 for driving the gate of S₁. A comparator 402 compares the output voltage Vₒᵤₜ to the desired voltage V_{ref}. A PID controller produces a DC signal from the error signal Vₑᵣᵣ. Simultaneously a comparator 404 compares the voltage on one side of the resonant tank Vₐ to the other side V_{b}. This provides the original phase of Vₐ, which is used to synchronise a ramp generator to be in phase. A final comparator 406 compares the in phase ramp signal to the DC signal to provide a gate drive signal for S₁.

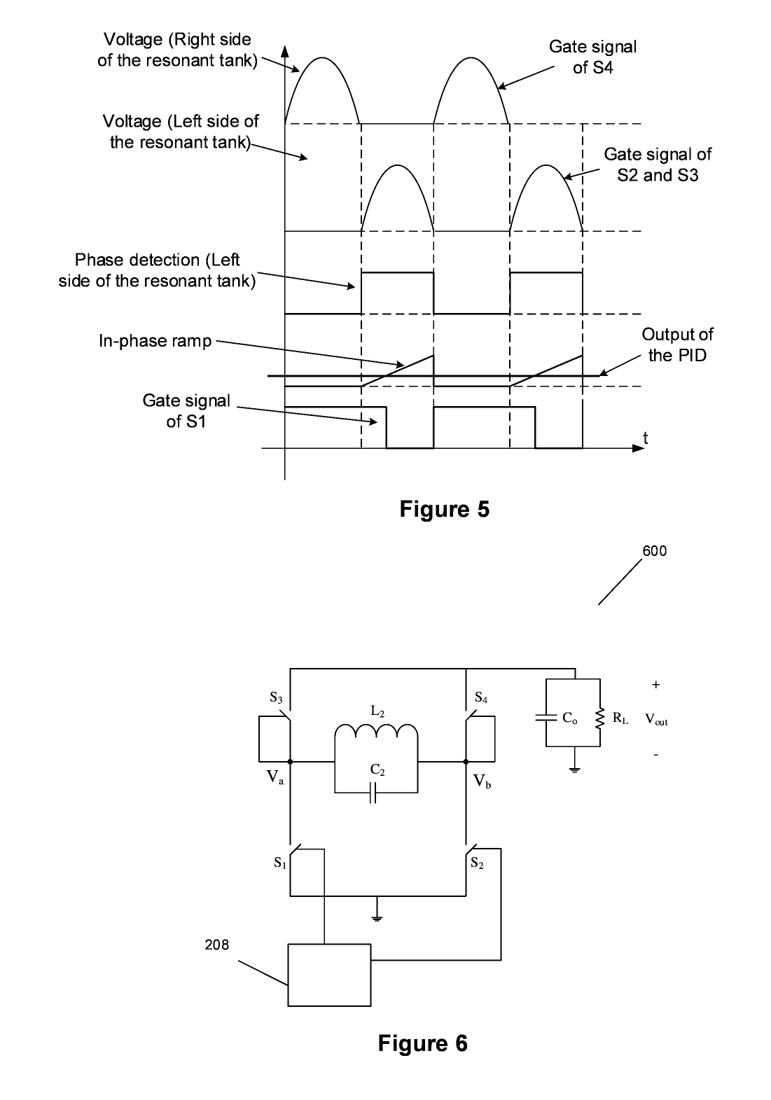

Operation of the controller 208 is shown in FIG. 5. The phase voltage error voltage is compared against the in-phase ramp signal. This comparison generates the gate signal for S₁.

As mentioned above other topologies are applicable. For example in FIG. 6 a converter 600 is shown where S₃ and S₄ are connected to switch autonomously, whereas S₁ and S₂ are actively controlled by controller 208 to provide regulation.

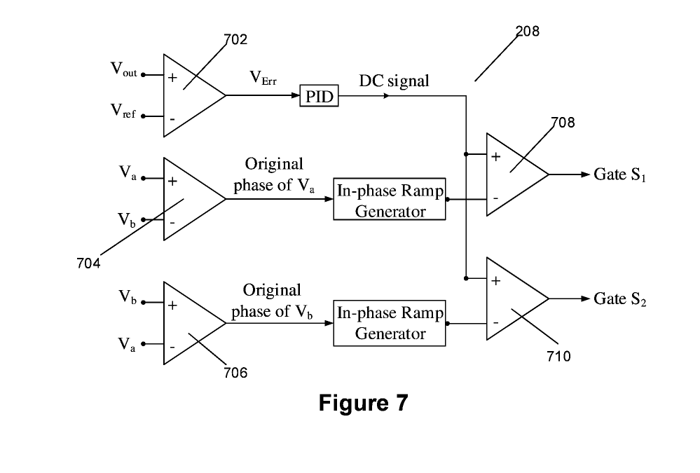

FIG. 7 gives an example of the controller 208 for the FIG. 6 converter. Similarly to FIG. 4, two comparators 702, 704 provide the Vₑᵣᵣ and the original phase of Vₐ. A third comparator 706 is connected oppositely and provides the original phase of V_{b}. The two separate in phase ramps are input to comparators 708, 710 respectively with the DC signal to generate the gate drive signals for S₁ and S₂.

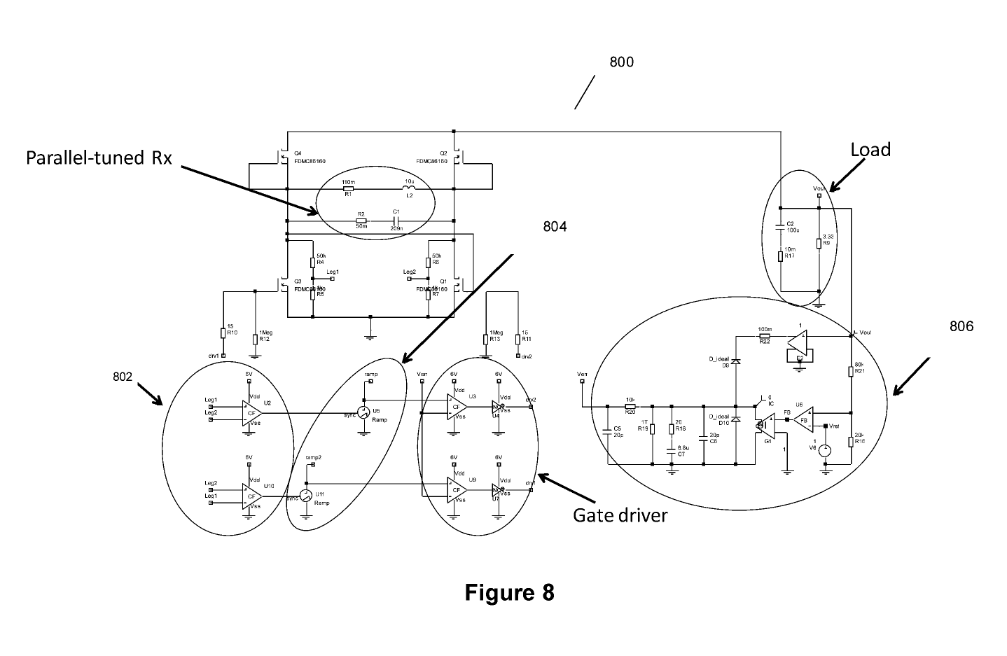

An example circuit design 800 for the controller 208 in FIG. 7 is shown in FIG. 8. Zero voltage crossing detectors 802 provide phase information for in-phase voltage ramps 804. This phase information is compared to a voltage error signal 806 to provide gate drive signals drv1 and drv2 for S₁ and S₂ respectively.

This form of semi-autonomous converter may reduce the component count, reduce size, increase efficiency, simplify gate control, and/or simplify the control algorithm.

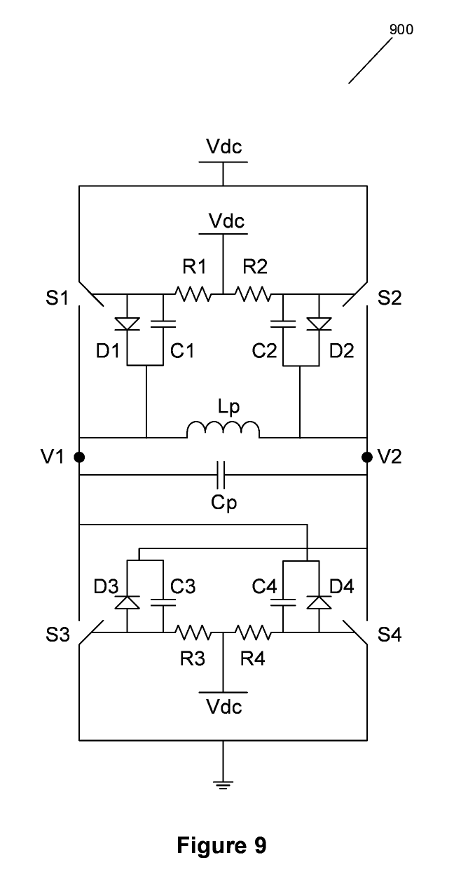

In a further example the rectification stage 205 may be fully autonomous. FIG. 9 shows an example of a fully autonomous full bridge converter 900. The gates of the switches S₁-S₄ are turned on and off using different parts of the circuit. For turn on S₁-S₄ are connected to the DC source VDC through a resistance (R₁-R₄) to charge the input capacitance. Turn off is achieved by connecting the gate to the respective side of the resonant tank via clamping diodes (D₁C₁-D₄C₄).

Switching occurs diagonally, eg::S₁ and S₄ are on simultaneously (D₁C₁ & D₄C₄ are connected to V₁) and similarly S₂ and S₃ are on simultaneously (D₂C₂ & D₃C₃ are connected to V₂).

When the voltage on one side of the resonant tank V₁ is high, D₁ and D₄ are reverse biased. Thus the voltage at the gates of S₁ and S₄ is high keeping the switches on through VDC. When V₁ goes low, D₁ and D₄ are forward biased which turns S₁ and S₄ off. A similar scenario occurs for S₂ and S₃ with 180 degrees phase shift.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver comprising:
a power pick up stage
a semi-autonomous converter connected to the power pick up stage; and
a controller configured to regulate the power delivered to a load based on at least one control device associated with the converter.

2. The inductive power receiver in claim 1 wherein the power pick up stage is resonant.

3. The inductive power receiver in claim 1 wherein the power pick up stage is a parallel tuned receiving coil.

4. The inductive power receiver in claim 1 wherein the three of the control devices associated with the converter are configured to operate autonomously.

5. The inductive power receiver in claim 1 wherein the two of the control devices associated with the converter are configured to operate autonomously.

6. The inductive power receiver in claim 1 wherein the at least one control device is controlled based on a feedback loop to regulate the output voltage.

7. The inductive power receiver in claim 4 wherein the feedback loop comprises an in phase ramp being compared against an output voltage error.

8. The inductive power receiver in claim 5 wherein the ramp is phase synchronised using a zero crossing detector.

9. An inductive power receiver comprising:
a power pick up stage
an autonomous converter connected to the power pick up stage supplying power to a load.

10. The inductive power receiver in claim 9 wherein the power pick up stage is resonant.

11. The inductive power receiver in claim 9 wherein the power pick up stage is a parallel tuned receiving coil.

12. The inductive power receiver in claim 9 wherein the converter comprises a full bridge fully autonomous converter including four switches.

13. The inductive power receiver in claim 12 further comprising a turn on circuit and a turn off circuit for each switch.

14. The inductive power receiver in claim 13 wherein the turn off circuit comprises a clamping diode connected to opposing side of the power pick up stage.

15. The inductive power receiver in claim 13 wherein the turn on circuit comprises a DC supply configured to connect to each switch gate via a respective resistor.
